(19) United States
(12) Patent Application Publication
(10) Pub. No.: US 2018/0338018 A1
(43) Pub. Date: Nov. 22, 2018

(54) HYBRID MIDDLEWARE DEVICE FOR FACILITATING COMMUNICATION AMONGST DEVICES OPERATING ON A DISTINCT COMMUNICATION PROTOCOLS

(71) Applicant: HCL TECHNOLOGIES LIMITED, Uttar Pradesh (IN)

(72) Inventors: YUVARAJAN S., TAMIL NADU (IN); SATHEESH N., TAMIL NADU (IN); SIVA SAKTHIVEL S., TAMIL NADU (IN)

(21) Appl. No.: 15/979,179

(22) Filed: May 14, 2018

(30) Foreign Application Priority Data
May 18, 2017 (IN) 201711017484

(51) Int. Cl. H04L 29/06; H04L 12/66

(52) U.S. Cl. CPC H04L 69/08; H04L 12/66

(57) ABSTRACT

Disclosed is a Hybrid middleware device for facilitating communication between at least two devices operating on a distinct communication protocols. An analyzer and interpreter module receives a first set of data packets, from a first device, to be transmitted to a second device. Upon receiving the first set of data packets, the analyzer and interpreter module determines a second set of communication protocols, supported by the second device, upon referring to a protocol configuration mapping file. In one aspect, the second set of communication protocols may be distinct from the first set of communication protocols. Subsequently, the protocol stack module converts the first set of data packets into a second set of data packets. Post conversion, the analyzer and interpreter module forwards the converted format, of the second set of data packets, to the second device thereby facilitating communication between at least two devices operating on a distinct communication protocols.

### CROSS REFERENCE TO RELATED APPLICATIONS

The present application claims priority from Indian Patent Application No. 201711017484 filed on 18 May, 2017 the entirety of which is hereby incorporated by reference.

### TECHNICAL FIELD

The present subject matter described herein, in general, relates to facilitate communication between at least two devices operating on a distinct communication protocols via a Hybrid middleware device.

### BACKGROUND

Communication protocols support has always been a challenge in a field of telecommunication. This is because different devices are operated on distinct communication protocols and thus becomes cumbersome to integrate the devices in order to facilitate communication amongst such devices. To cope up with the challenge, people are either forced to make changes in existing setup/software to facilitate the communication or need to use multiple gateways and/or devices to support different devices operating on distinct communication protocols. However, such changes in the existing setup/software and use multiple gateways and/or devices may lead to a complex communication architecture and incur higher cost.

### SUMMARY

Before the present systems and methods, are described, it is to be understood that this application is not limited to the particular systems, and methodologies described, as there can be multiple possible embodiments which are not expressly illustrated in the present disclosure. It is also to be understood that the terminology used in the description is for the purpose of describing the particular versions or embodiments only, and is not intended to limit the scope of the present application. This summary is provided to introduce concepts related to systems and methods for facilitating communication between at least two devices operating on a distinct communication protocols and the concepts are further described below in the detailed description. This summary is not intended to identify essential features of the claimed subject matter nor is it intended for use in limiting the scope of the claimed subject matter.

In one implementation, a Hybrid middleware device for facilitating communication between at least two devices operating on a distinct communication protocols is disclosed. The Hybrid middleware device may comprise a processor and a memory coupled to the processor. The processor may execute a plurality of modules present in the memory. The plurality of modules may comprise an analyzer and interpreter module and a protocol stack module. The analyzer and interpreter module may receive a first set of data packets, from a first device, to be transmitted to a second device. In one aspect, the first set of data packets may be received in a format associated to the first set of communication protocols. It may be understood that the first device may be operative on a first set of communication protocols. The analyzer and interpreter module may further determine a second set of communication protocols supported by the second device upon referring to a protocol configuration mapping file. In one aspect, the second set of communication protocols may be distinct from the first set of communication protocols. The protocol stack module may convert the first set of data packets into a second set of data packets. In one aspect, the second set of data packets may be converted in a converted format associated to at least one of the second set of communication protocols. The analyzer and interpreter module may further forward the converted format, of the second set of data packets, to the second device thereby facilitating communication between at least two devices operating on a distinct communication protocols.

In another implementation, a method for facilitating communication between at least two devices operating on a distinct communication protocols is disclosed. In order to facilitate the communication, a first set of data packets may be received from a first device. It may be understood that the first set of data packets is to be transmitted to a second device. In one aspect, the first set of data packets may be received in a format associated to the first set of communication protocols. It may be understood that the first device may be operative on a first set of communication protocols. Upon receiving the first set of data packets, a second set of communication protocols, supported by the second device, may be determined upon referring to a protocol configuration mapping file. In one aspect, the second set of communication protocols may be distinct from the first set of communication protocols. Subsequent to the determination of the second set of communication protocols, the first set of data packets may be converted into a second set of data packets. In one aspect, the second set of data packets may be converted in a converted format associated to at least one of the second set of communication protocols. Post conversion, the converted format, of the second set of data packets, may be forwarded to the second device thereby facilitating communication between at least two devices operating on a distinct communication protocols. In one aspect, the aforementioned method for facilitating the communication between the at least two devices operating on the distinct communication protocols may be performed by a processor using programmed instructions stored in a memory.

In yet another implementation, non-transitory computer readable medium embodying a program executable in a computing device for facilitating communication between at least two devices operating on a distinct communication protocols is disclosed. The program may comprise a program code for receiving a first set of data packets, from a first device, to be transmitted to a second device, wherein the first set of data packets is received in a format associated to the first set of communication protocols, and wherein the first device operative on a first set of communication protocols. The program may further comprise a program code for determining a second set of communication protocols supported by the second device upon referring to a protocol configuration mapping file, wherein the second set of communication protocols is distinct from the first set of communication protocols. The program may further comprise a program code for converting the first set of data packets into a second set of data packets, wherein the second set of data packets is converted in a converted format associated to at least one of the second set of communication protocols. The program may further comprise a program code for forwarding the converted format, of the second set of data packets, to the second device thereby facilitating communication between at least two devices operating on a distinct communication protocols.

### BRIEF DESCRIPTION OF THE DRAWINGS

The foregoing detailed description of embodiments is better understood when read in conjunction with the appended drawings. For the purpose of illustrating the disclosure, example constructions of the disclosure are shown in the present document; however, the disclosure is not limited to the specific methods and apparatus disclosed in the document and the drawings.

The detailed description is given with reference to the accompanying figures. In the figures, the left-most digit(s) of a reference number identifies the figure in which the reference number first appears. The same numbers are used throughout the drawings to refer like features and components.

FIG. 1 illustrates a network implementation of a Hybrid middleware device for facilitating communication between at least two devices operating on a distinct communication protocols, in accordance with an embodiment of the present subject matter.

FIG. 2 illustrates the Hybrid middleware device, in accordance with an embodiment of the present subject matter.

FIGS. 3 to 9 illustrate various embodiments of the Hybrid middleware device for facilitating communication.

FIG. 10 illustrates a method for facilitating the communication between the at least two devices operating on the distinct communication protocols, in accordance with an embodiment of the present subject matter.

### DETAILED DESCRIPTION

Some embodiments of this disclosure, illustrating all its features, will now be discussed in detail. The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise. Although any systems and methods similar or equivalent to those described herein can be used in the practice, the exemplary, systems and methods are now described. The disclosed embodiments are merely exemplary of the disclosure, which may be embodied in various forms.

Various modifications to the embodiment will be readily apparent to those skilled in the art and the generic principles herein may be applied to other embodiments. However, one of ordinary skill in the art will readily recognize that the present disclosure is not intended to be limited to the embodiments illustrated, but is to be accorded the widest scope consistent with the principles and features described herein.

The proposed invention is a Hybrid middleware device for facilitating communication between at least two devices operating on distinct communication protocols is disclosed. It may be understood that the Hybrid middleware device can either a hardware or a software, or a combination of hardware components and software modules. The Hybrid middleware device may facilitate a user to handle multiple devices, manufactured by different vendors, for data communication. It may be noted that each device may be operated on a distinct communication protocol than other device. Examples of the device may include, but not limited to, Internet of Things (IoT) device and IoT gateways. Examples of the communication protocol may include, but not limited to, MOTT, REST, AMQP, XMPP, and SOAP.

In order to facilitate the data communication among multiple devices operating on distinct communication protocols, the Hybrid middleware device may act as an intermediator device through which each data packet is transmitted from a source device to a destination device. It may be understood that a data packet transmitted is received in a format associated to a communication protocol supported by the source device. Upon receipt of the data packet from the source device, the Hybrid middleware device converts the format of the data packet in accordance with the communication protocol supported by the destination device. Post conversion, the Hybrid middleware device forwards the data packet, in converted format, to the destination device thereby facilitating communication between the at least two devices operating on the distinct communication protocols.

While aspects of described system and method for facilitating the communication between the at least two devices operating on the distinct communication protocols may be implemented in any number of different computing systems, environments, and/or configurations, the embodiments are described in the context of the following exemplary Hybrid middleware device.

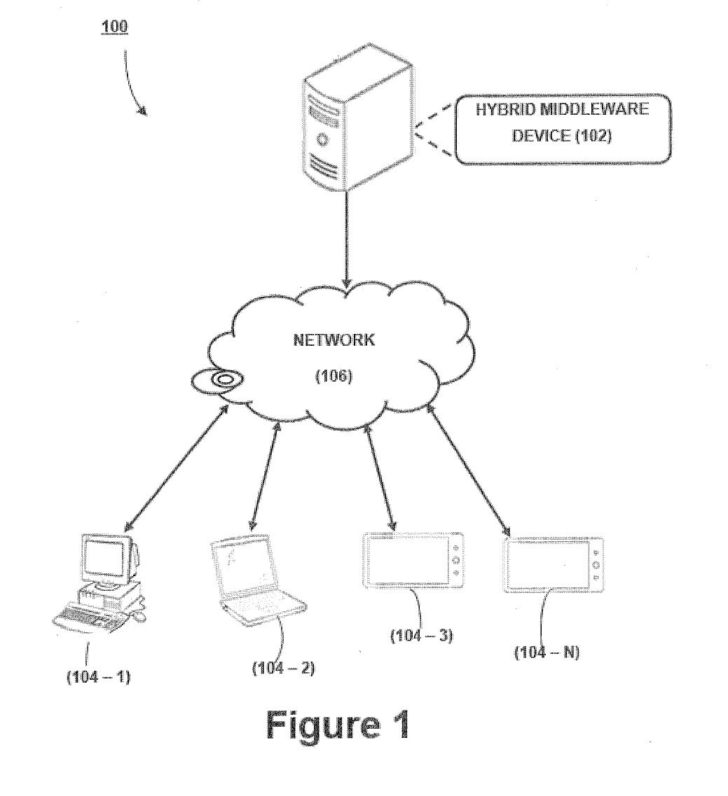

Referring now to FIG. 1, a network implementation 100 of a Hybrid middleware device 102 for facilitating communication between at least two devices operating on a distinct communication protocols is disclosed. In order to facilitate the communication, the Hybrid middleware device 102 receives a first set of data packets from a first device. The first set of data packets is to be transmitted to a second device. In one aspect, the first set of data packets may be received in a format associated to the first set of communication protocols. It may be understood that the first device may be operative on a first set of communication protocols. Upon receiving the first set of data packets, the Hybrid middleware device 102 determines a second set of communication protocols, supported by the second device, upon referring to a protocol configuration mapping file. In one aspect, the second set of communication protocols may be distinct from the first set of communication protocols. Subsequent to the determination of the second set of communication protocols, the Hybrid middleware device 102 converts the first set of data packets into a second set of data packets. In one aspect, the second set of data packets may be converted in a converted format associated to at least one of the second set of communication protocols. Post conversion, the Hybrid middleware device 102 forwards the converted format, of the second set of data packets, to the second device thereby facilitating communication between at least two devices operating on a distinct communication protocols.

Although the present disclosure is explained considering that the Hybrid middleware device 102 is implemented on a server, it may be understood that the Hybrid middleware device 102 may be implemented in a variety of computing systems, such as a laptop computer, a desktop computer, a notebook, a workstation, a mainframe computer, a server, a network server, a cloud-based computing environment. It will be understood that the Hybrid middleware device 102 may be accessed by multiple users through one or more user devices 104-1, 104-2 . . . 104-N, collectively referred to as user 104 or stakeholders, hereinafter, or applications residing on the user devices 104. In one implementation, the Hybrid middleware device 102 may comprise the cloud-based computing environment in which a user may operate individual computing systems configured to execute remotely located applications. Examples of the user devices 104 may include, but are not limited to, a IoT device, IoT gateway, portable computer, a personal digital assistant, a handheld device, and a workstation. The user devices 104 are communicatively coupled to the Hybrid middleware device 102 through a network 106.

In one implementation, the network 106 may be a wireless network, a wired network or a combination thereof. The network 106 can be implemented as one of the different types of networks, such as intranet, local area network (LAN), wide area network (WAN), the internet, and the like. The network 106 may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further the network 106 may include a variety of network devices, including routers, bridges, servers, computing devices, storage devices, and the like.

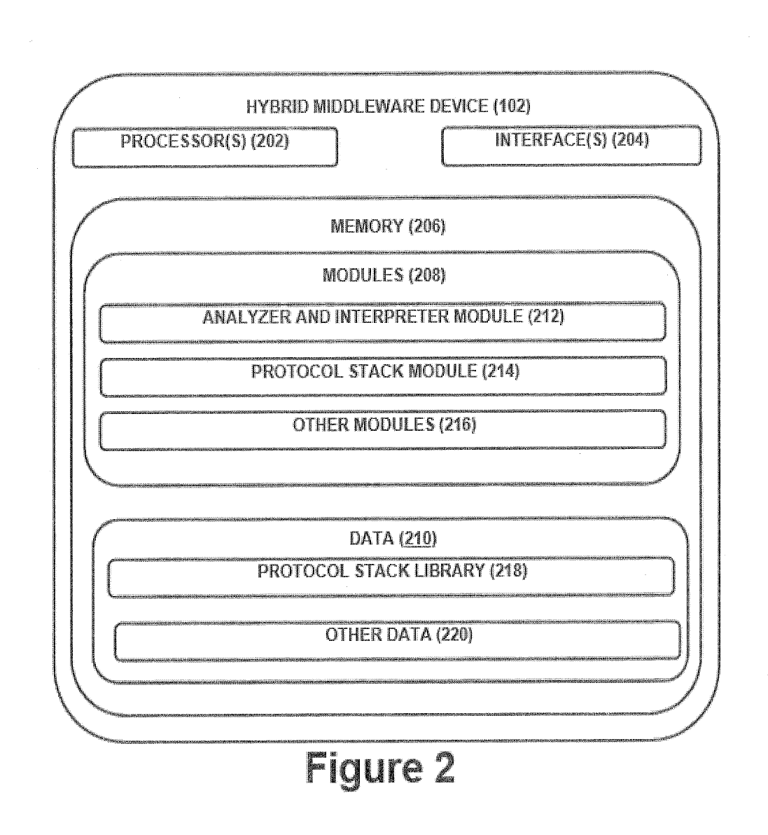

Referring now to FIG. 2, the Hybrid middleware device 102 is illustrated in accordance with an embodiment of the present subject matter. In one embodiment, the Hybrid middleware device 102 may include at least one processor 202, an input/output (I/O) interface 204, and a memory 206. The at least one processor 202 may be implemented as one or more microprocessors, microcomputers, microcontrollers, digital signal processors, central processing units, state machines, logic circuitries, and/or any devices that manipulate signals based on operational instructions. Among other capabilities, the at least one processor 202 is configured to fetch and execute computer-readable instructions stored in the memory 206.

The I/O interface 204 may include a variety of software and hardware interfaces, for example, a web interface, a graphical user interface, and the like. The I/O interface 204 may allow the Hybrid middleware device 102 to interact with the user directly or through the user devices 104. Further, the I/O interface 204 may enable the Hybrid middleware device 102 to communicate with other computing devices, such as web servers and external data servers (riot shown). The I/O interface 204 can facilitate multiple communications within a wide variety of networks and protocol types, including wired networks, for example, LAN, cable, etc., and wireless networks, such as WLAN, cellular, or satellite. The I/O interface 204 may include one or more ports for connecting a number of devices to one another or to another server.

The memory 206 may include any computer-readable medium or computer program product known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. The memory 206 may include modules 208 and data 210.

The modules 208 include routines, programs, objects, components, data structures, etc., which perform particular tasks or implement particular abstract data types. In one implementation, the modules 208 may include an analyzer and interpreter module 212, a protocol stack module 214, and other modules 216. The other modules 216 may include programs or coded instructions that supplement applications and functions of the Hybrid middleware device 102. The modules 208 described herein may be implemented as software modules that may be executed in the cloud-based computing environment of the Hybrid middleware device 102.

The data 210, amongst other things, serves as a repository for storing data processed, received, and generated by one or more of the modules 208. The data 210 may also include a protocol stack library 218 and other data 220. The other data 220 may include data generated as a result of the execution of one or more modules in the other modules 216.

As there are various challenges observed in the existing art, the challenges necessitate the need to build the Hybrid middleware device 102 for facilitating communication between at least two devices operating on distinct communication protocols. It may be understood that the Hybrid middleware device 102 is combination of hardware and/or software module that may facilitate the user to handle multiple IoT devices/gateways from different vendors, wherein the IoT devices/gateways are using distinct communication protocols. In order to facilitate the communication, at first, a user may use the user device 104 to access the Hybrid middleware device 102 via the I/O interface 204. The user may register them using the I/O interface 204 to use the Hybrid middleware device 102. In one aspect, the user may access the I/O interface 204 of the Hybrid middleware device 102. In order to facilitate the communication, the Hybrid middleware device 102 may employ the analyzer and interpreter module 212 the protocol stack module 214. The detail functioning of the modules is described below with the help of figures.

The analyzer and interpreter module 212 receives a first set of data packets, from a first device, to be transmitted to a second device. In one aspect, the first set of data packets may be received in a format associated to the first set of communication protocols. It may be understood that the first device may be operative on a first set of communication protocols stored in the protocol stack library 218. Examples of a device including the first device and the second device may include, but not limited to, Internet of Things (IoT) device and IoT gateway. Examples of the communication protocol may include, but not limited to, MOTT, REST, AMQP, XMPP, and SOAP.

After receiving the first set of data packets, the analyzer and interpreter module 212 determines a second set of communication protocols supported by the second device. It may be understood that the second set of communication protocols is distinct from the first set of communication protocols. The second set of communication protocols may be determined upon referring to a protocol configuration mapping file. In one aspect, the protocol configuration mapping file may comprise mapping of one or more communication protocols supported by the first device and the second device. In other words, the protocol configuration mapping file indicates communication protocol usage information by each device. This communication protocol usage information is further used as an input by the analyzer and interpreter module 212 during conversion of the first set of data packets as per the communication protocol used by the second device. It may be noted that since the protocol configuration mapping file stores the communication protocol usage information, the user may anytime update the protocol configuration mapping file with an updated communication protocol usage information pertaining to any device. In addition to the above, the protocol configuration mapping file may further comprise an identification address of the second device to whom the data packet(s) is to be forwarded and communication protocol(s) supported by the second device.

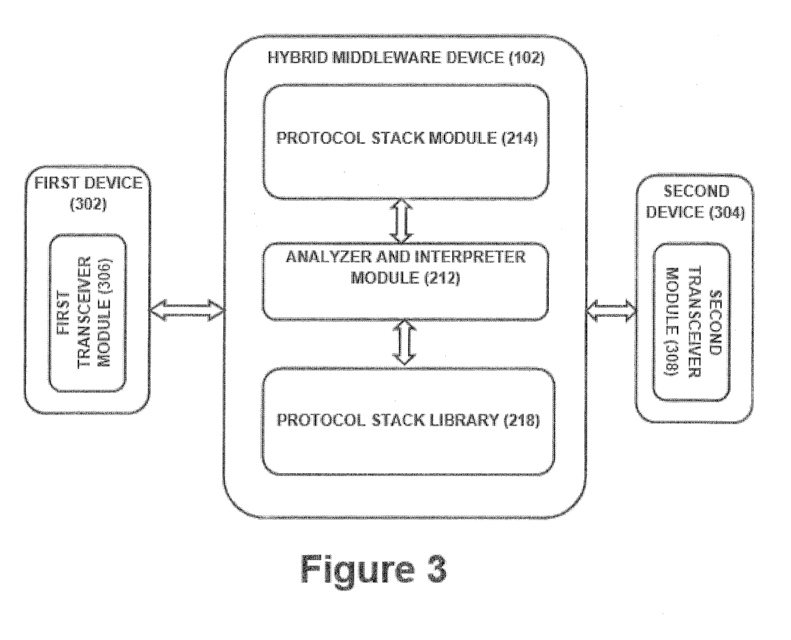

Referring now to the FIG. 3. In order to elucidate the functioning of the analyzer and interpreter module 212, as aforementioned, consider an example where the first device 302, hereinafter referred to as an IoT device 302, needs to transmit data packets to the second device 304, hereinafter referred to as IoT gateway 304. It may be noted that the IoT device 302 and the IoT gateway 304 comprise a first transceiver 306 and a second transceiver 308 respectively. The IoT device 302 transmits the data packets to the IoT gateway 304 via an intermediator device herein referred to as the Hybrid middleware device 102. It is to be noted that the IoT device operates on MQTT protocol whereas the IoT gateway operates on REST protocol. In order to transmit the data packets, the first transceiver 306 receives the data packets from any gateway/server irrespective of communication protocol restriction. After successful reception of the data packets, the first transceiver 306 provides the data packets as an input to the analyzer and interpreter module 212 for further analysis and format conversion.

It is to be noted that the Hybrid middleware device 102 receives the data packets from the IoT device 302 in a format associated to the MQTT protocol. Upon receipt of the data packets, the analyzer and interpreter module 212 determines a protocol supported by the IoT gateway 304. The Hybrid middleware device 102 forwards the data packets to the IoT gateway 304, if the IoT gateway 304 also supports the MQTT protocol. Since the IoT gateway 304 is operated on the REST protocol, the analyzer and interpreter module 212 determines the communication protocol as REST protocol. Based on determination of the communication protocol supported by the IoT gateway 304, the Hybrid middleware device 102 forwards a request to the protocol stack module 214 for converting the data packets, in MQTT format, to data packets in REST format.

Based on the above, the protocol stack module 214 converts the first set of data packets into a second set of data packets. The second set of data packets may be converted in a converted format associated to at least one of the second set of communication protocols. The protocol stack module 214 converts the first set of data packets based on at least one predefined conversion function, corresponding to each communication protocol, stored in the protocol stack library 218. Once the first set of data packets is converted into the second set of data packets, the analyzer and interpreter module 212 then forwards the converted format, of the second set of data packets, to the second device 304.

In order to explain the above, consider the example same as aforementioned. Since the IoT gateway 304 is operated on the REST protocol different than the MQTT protocol, the protocol stack module 214 converts the format of the data packet, associated to the REST protocol, into a format associated to the REST protocol upon referring to the protocol stack library 218. Post conversion, the analyzer and interpreter module 212 forwards the format of the data packets, associated to the REST protocol, to the IoT gateway 304. The data packets, post conversion, are then received by the second transceiver 308 present in the IoT gateway 308. Thus, in this manner, the Hybrid middleware device 102 facilitates the data communication between at least two devices operating on the distinct communication protocols.

Though the above description is described with respect to an exemplary embodiment, wherein the transmission of the data packets between the first device and the second device has occurred via the Hybrid middleware device 102. It may be noted that there can be various other embodiments of the proposed Hybrid middleware device 102 which are described with the help of their respective figures.

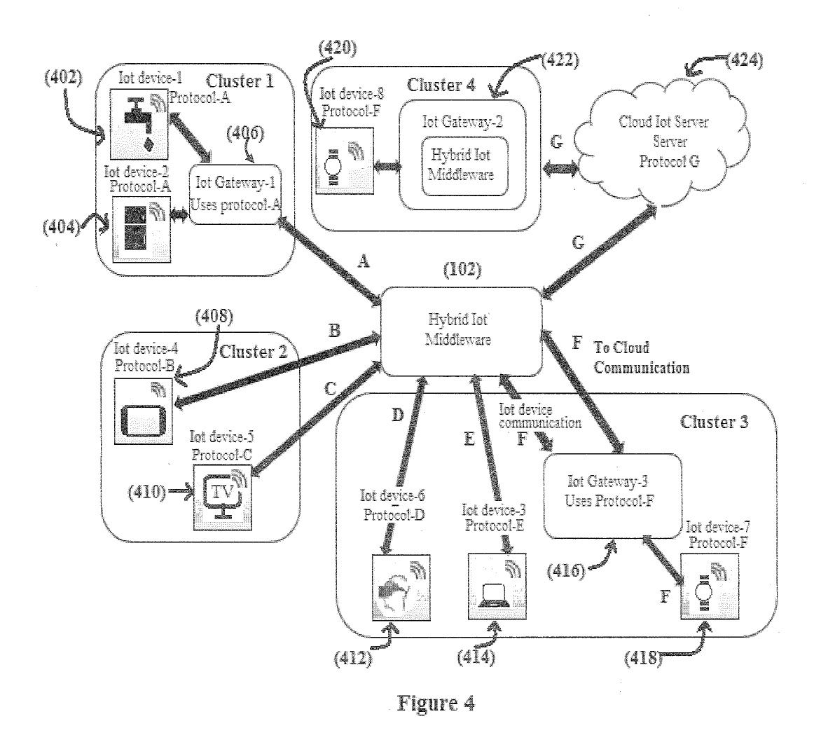

Now referring to a FIG. 4, a setup block diagram of the Hybrid middleware device 102. Each cluster illustrates different operational modes of the Hybrid middleware device 102. As illustrated, there are four clusters i.e. Cluster-1, Cluster-2 Cluster-3, and Cluster-4. In one example the Cluster-1 comprises an IoT device-1 402 and IoT device-2 404 connected to a IoT gateway-1 406 which is further connected to the Hybrid middleware device 102. It may further be noted that the IoT device-1 402 and the IoT device-2 404 and the IoT gateway-1 406 are operating on Protocol-A. Similarly, the Cluster-2 comprises an IoT device-4 408 and an IoT device-5 410. Both the IoT device-4 408 and the IoT device-5 410 are operated on distinct protocols i.e. Protocol-B and Protocol-C respectively and are connected to the Hybrid middleware device 102. Similarly, the Cluster 3 comprises an IoT device-6 412, an IoT device-3 414, an IoT gateway-3 416, and an IoT device-7 418. The IoT device-6 412 and the IoT device-3 414 are operated on the Protocol-D and Protocol-E respectively and are connected to the Hybrid middleware device 102. As illustrated, the IoT device-7 418 is connected to the Hybrid middleware device 102 via the IoT gateway-3 416, wherein the IoT gateway-3 416 and the IoT device-7 418 are operated on a same protocol i.e. Protocol-F. Similarly, the Cluster-4 comprises an IoT device-8 420 and an IoT gateway-2 422, wherein both the IoT device-8 420 and the IoT gateway-2 422 are operated on a same protocol i.e. Protocol-F. It may further be noted that all the Clusters needs to transmit the data packets to a Cloud IoT server 424 which is operated on Protocol-U. This transmission of the data packets may be facilitated with the help of the Hybrid middleware device 102. All operational models present in the FIG. 4 are further described below with the help of figures.

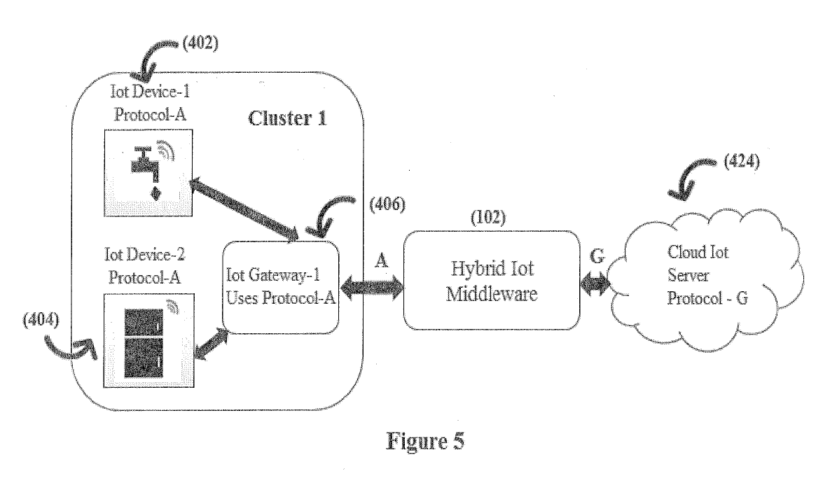

Referring now to FIG. 5. In this operational mode, it is to be noted that the IoT device-1 402 and the IoT device-2 404 are connected to the IoT gateway-1 406. Further it is to be noted that the IoT device-1 402, the IoT device-2 404, and the IoT gateway-1 406 are supporting the same communication protocol (i.e. Protocol-A). However, the Cloud IoT server 424 is operated on the Protocol-G, therefore in order to facilitate the data communication amongst them, the Hybrid middleware device 102 converts the format of the data packets, transmitted either by the IoT device-1 402 or the IoT device-2 404, in a format associated to the Protocol-G.

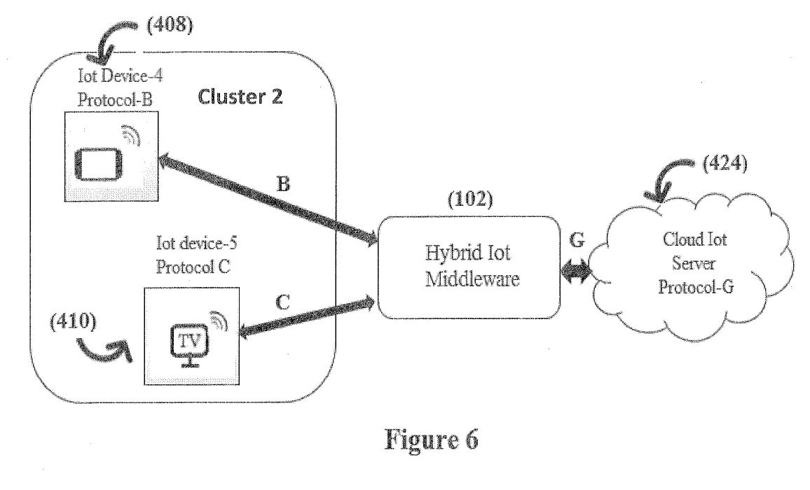

Referring now to FIG. 6. In this operational mode, the IoT device-4 408 and IoT device-5 410 supporting the communication protocols B and C respectively are directly connected to Hybrid middleware device 102. On the other hand, the Cloud IoT server 424 is operated on the Protocol-G, therefore in order to facilitate the data communication amongst them, the Hybrid middleware device 102 converts the format of the data packets, transmitted either by the IoT device-4 408 and IoT device-5 410, in a format associated to the Protocol-G.

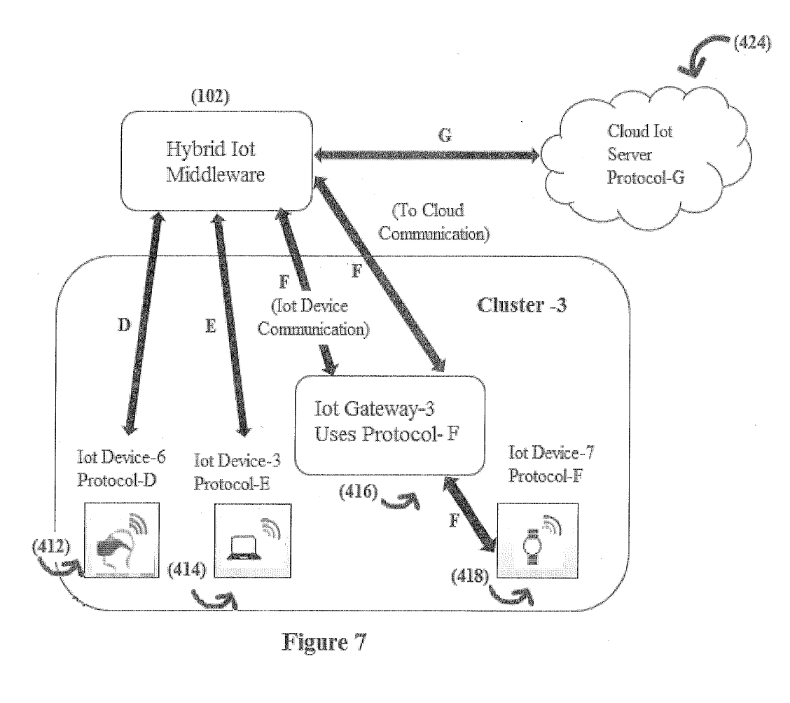

Referring now to FIG. 7. In this operational mode, the IoT device-3 414 and the IoT device-6 412 are directly connected to the Hybrid middleware device 102. On the other hand, the IoT device-7 418 is connected to the Hybrid middleware device 102 via the IoT gateway-3 416. It may be understood that if any of the IoT device-3 414 and the IoT device-6 412 transmit the data packets to the Cloud IoT server 424, the Hybrid middleware device 102 converts the format of the data packets, transmitted either by the IoT device-3 414 and the IoT device-6 412, in a format associated to the Protocol-G. On the other hand, if the IoT device-7 418 transmits the data packets via the IoT gateway-3 416, in a format associated to the Protocol-F, the Hybrid middleware device 102 converts the format of the data packets in a format associated to the Protocol-G.

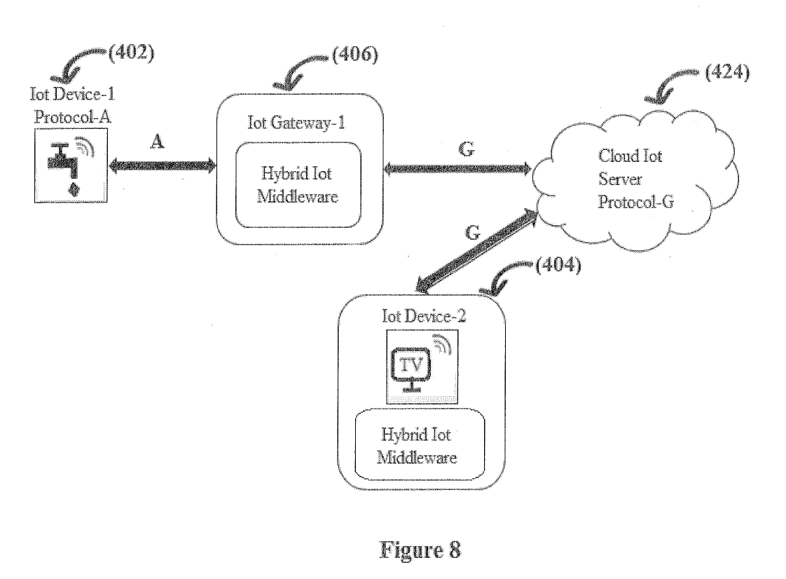

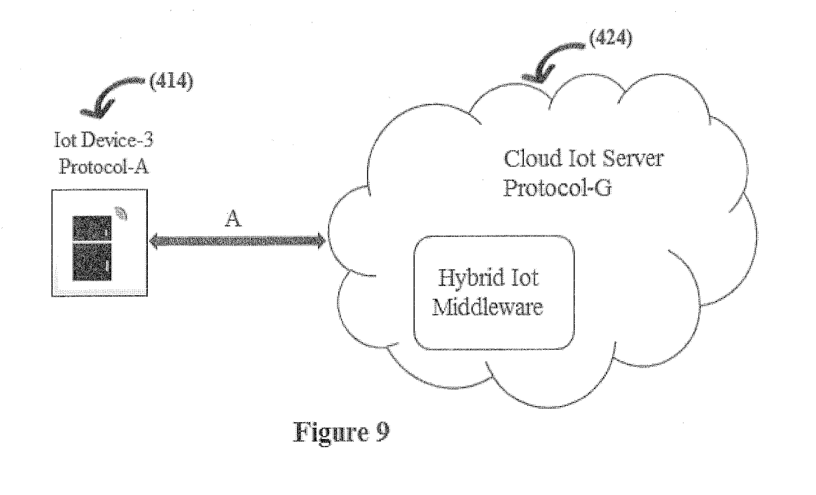

Referring now to FIG. 8. In this operational mode, the Hybrid middleware device 102 is used as part of firmware of the IoT device-2 404 and IoT gateway-1 406. So that the IoT device-2 404 and IoT gateway-1 406 may communicate with the Cloud IoT server 424 without any Hybrid middleware device 102. Referring now to FIG. 9. In this operational model the Hybrid middleware device 102 is used as part of the Cloud IoT server 424. So that IoT devices/Gateways operating on any communication protocol may communicate with the Cloud IoT server 424 without the Hybrid middleware device 102.

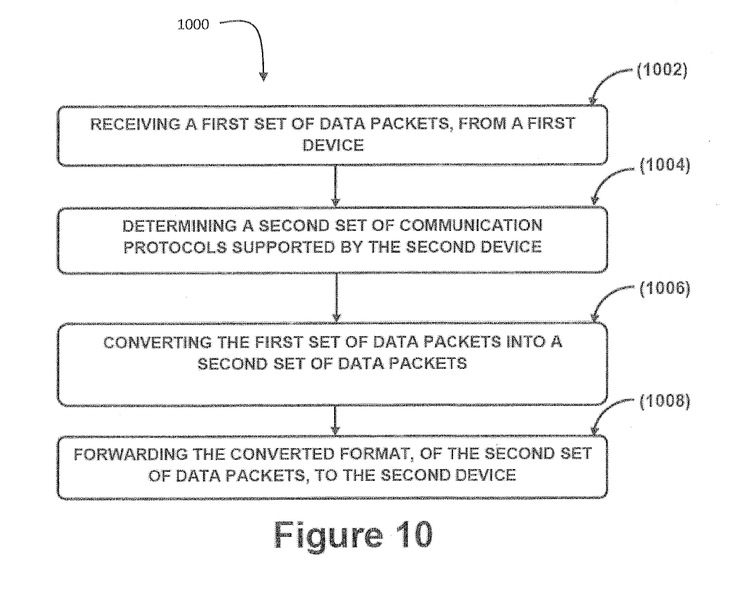

Referring now to FIG. 10, a method 1000 for facilitating communication between at least two devices operating on distinct communication protocols is shown, in accordance with an embodiment of the present subject matter. The method 1000 may be described in the general context of computer executable instructions. Generally, computer executable instructions can include routines, programs, objects, components, data structures, procedures, modules, functions, etc., that perform particular functions or implement particular abstract data types. The method 1000 may also be practiced in a distributed computing environment where functions are performed by remote processing devices that are linked through a communications network. In a distributed computing environment, computer executable instructions may be located in both local and remote computer storage media, including memory storage devices.

The order in which the method 1000 is described is not intended to be construed as a limitation, and any number of the described method blocks can be combined in any order to implement the method 1000 or alternate methods. Additionally, individual blocks may be deleted from the method 1000 without departing from the spirit and scope of the subject matter described herein. Furthermore, the method can be implemented in any suitable hardware, software, firmware, or combination thereof. However, for ease of explanation, in the embodiments described below, the method 1000 may be considered to be implemented as described in the Hybrid middleware device 102.

At block 1002, a first set of data packets may be received from a first device. The first set of data packets received is to be transmitted to a second device. In one aspect, the first set of data packets may be received in a format associated to the first set of communication protocols. It may be understood that the first device may be operative on a first set of communication protocols. In one implementation, the first set of data packets may be received by the analyzer and interpreter module 212.

At block 1004, a second set of communication protocols supported by the second device may be determined upon referring to a protocol configuration mapping file. In one aspect, the second set of communication protocols is distinct from the first set of communication protocols. In one implementation, the second set of communication protocols may be determined by the analyzer and interpreter module 212.

At block 1006, the first set of data packets may be converted into a second set of data packets. In one aspect, the second set of data packets may be converted in a converted format associated to at least one of the second set of communication protocols. In one implementation, the first set of data packets may be converted by the protocol stack module 214.

At block 1008, the converted format, of the second set of data packets, may be forwarded to the second device thereby facilitating communication between at least two devices operating on distinct communication protocols. In one implementation, the converted format may be forwarded by the analyzer and interpreter module 212.

Exemplary embodiments discussed above may provide certain advantages. Though not required to practice aspects of the disclosure, these advantages may include those provided by the following features.

Some embodiments enable a system and a method to facilitate data communication where multiple IoT gateways/devices of different protocols are used.

Some embodiments enable a system and a method to provide a single hardware/software solution for integration of devices operating on any communication protocol.

Some embodiments enable a system and a method to reduce effort and cost of installing separate gateway(s) for facilitating data communication amongst devices operating on different communication protocols.

Some embodiments enable a system and a method to avoids/reduces maintenance of separate servers for different communication protocols.

Some embodiments enable a system and a method to serve Business to Business model operations where two different enterprises are using distinct protocols and wanted to get collaborate with each other.

Although implementations for methods and systems for facilitating communication between at least two devices operating on distinct communication protocols have been described in language specific to structural features and/or methods, it is to be understood that the appended claims are not necessarily limited to the specific features or methods described. Rather, the specific features and methods are disclosed as examples of implementations for facilitating the communication between the at least two devices.

1. A method for facilitating communication between at least two devices operating on distinct communication protocols, the method comprising:
receiving, by a Hybrid middleware device, a first set of data packets, from a first device, to be transmitted to a second device, wherein the first set of data packets is received in a format associated to a first set of communication protocols, and wherein the first device is operative on the first set of communication protocols;
determining, by the Hybrid middleware device, a second set of communication protocols supported by the second device upon referring to a protocol configuration mapping file, wherein the second set of communication protocols is distinct from the first set of communication protocols;
converting, by the Hybrid middleware device, the first set of data packets into a second set of data packets, wherein the second set of data packets is converted in a converted format associated to at least one of the second set of communication protocols; and
forwarding, by the Hybrid middleware device, the converted format, of the second set of data packets, to the second device thereby facilitating communication between at least two devices operating on distinct communication protocols.

2. The method of claim 1, wherein the protocol configuration mapping file comprises mapping of one or more communication protocols supported by the first device and the second device.

3. The method of claim 1, wherein the first set of data packets is converted based on at least one predefined conversion function, corresponding to each communication protocol, stored in a protocol stack library.

4. The method of claim 1, wherein the first set of data packets is received from a first transceiver module present in the first device, and wherein the second set of data packets, upon conversion, is transmitted to a second transceiver module present in the second device.

5. A Hybrid middleware device for facilitating communication between at least two devices operating on distinct communication protocols, the Hybrid middleware device comprising:
a processor; and
a memory coupled to the processor, wherein the processor is capable of executing a plurality of modules stored in the memory, and wherein the plurality of modules comprising:
an analyzer and interpreter module for:
receiving a first set of data packets, from a first device, to be transmitted to a second device, wherein the first set of data packets is received in a format associated to a first set of communication protocols, and wherein the first device is operative on the first set of communication protocols,
a second set of communication protocols supported by the second device upon referring to a protocol configuration mapping file, wherein the second set of communication protocols is distinct from the first set of communication protocols;
a protocol stack module for converting the first set of data packets into a second set of data packets, wherein the second set of data packets is converted in a converted format associated to at least one of the second set of communication protocols; and
the analyzer and interpreter module for forwarding the converted format, of the second set of data packets, to the second device thereby facilitating communication between at least two devices operating on distinct communication protocols.

6. The Hybrid middleware device of claim 5, wherein the protocol configuration mapping file comprises mapping of one or more communication protocols supported by the first device and the second device.

7. The Hybrid middleware device of claim 5, wherein the protocol stack module converts the first set of data packets based on at least one predefined conversion function, corresponding to each communication protocol, stored in a protocol stack library.

8. The Hybrid middleware device of claim 5, wherein the analyzer and interpreter module receives the first set of data packets from a first transceiver module of the first device, and wherein the analyzer and interpreter module transmits the second set of data packets, upon conversion, to a second transceiver module of the second device.

9. A non-transitory computer readable medium embodying a program executable in a computing device for facilitating communication between at least two devices operating on distinct communication protocols, the program comprising a program code:
a program code for receiving a first set of data packets, from a first device, to be transmitted to a second device, wherein the first set of data packets is received in a format associated to a first set of communication protocols, and wherein the first device is operative on the first set of communication protocols;
a program code for determining a second set of communication protocols supported by the second device upon referring to a protocol configuration mapping file, wherein the second set of communication protocols is distinct from the first set of communication protocols;
a program code for converting the first set of data packets into a second set of data packets, wherein the second set of data packets is converted in a converted format associated to at least one of the second set of communication protocols; and
a program code for forwarding the converted format, of the second set of data packets, to the second device thereby facilitating communication between at least two devices operating on distinct communication protocols.
